(19) United States
(12) Patent Application Publication
(10) Pub. No.: US 2009/0046889 A1
(43) Pub. Date: Feb. 19, 2009

(54) SPEAKER

(75) Inventor: Kun-Li Huang, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHENG UEI PRECISION INDUSTRY CO., LTD., Taipei Hsien (TW)

(21) Appl. No.: 11/838,545

(22) Filed: Aug. 14, 2007

(51) Int. Cl. H04R 1/00

(52) U.S. Cl. 381/433

(57) ABSTRACT

The present invention relates to a speaker which includes a frame module. The frame module includes a frame body defining a gap thereon, a printed circuit board disposed on a rear surface of the frame body, a magnet mounted in the frame body, and a magnetic washer disposed before the magnet and in the frame body. A phonation module includes a diaphragm and a voice coil assembled in the frame body and surrounding the magnet and the magnetic washer. Two lead wires are led out from the voice coil and led out of the speaker through the gap of the frame body. The voice coil adheres to a back surface of the diaphragm. A steel mask with meshes is mounted in front of the diaphragm.

### BACKGROUND OF THE INVENTION

1. Field of the Invention

The present invention relates to a speaker, and more particularly to a speaker which improves the sound effects thereof.

2. The Related Art

As we know that speakers have been broadly used in varieties of applications, such as, telephones, computers, radios, microphones, etc. The speakers are electroacoustic devices and used for converting electric signals into acoustic signals.

Conventionally, a speaker includes a frame module and a phonation module. The frame module includes a frame body engaging with a magnet, a yoke and a printed circuit board. The phonation module that integrates with the frame module includes a voice coil, a diaphragm, and a locating ring which defines a locating point thereon. The diaphragm is located in the locating ring and connected to the voice coil. Two lead wires are led out from the voice coil. The lead wires keep close to the surface of the diaphragm and are fixed on the locating ring through the locating point defined on the locating ring. After assembling the frame module and the phonation module, a cover is coupled with the phonation module. The frame module, the phonation module and the cover are fixed together, and then the speaker is formed. Subsequently, test the speaker to judge the properties of the speaker are good or not.

However, the lead wires of the voice coil are close to the diaphragm and are located on the locating ring. The design brings a bad influence to the sound effects of the speaker and causes a much bad frequency distortion in a range of frequency. Further more, the test is performed after the frame module, the phonation module and the cover are fixed together, so if the properties of the speaker are not good, it is hard to adjust the speaker, and the speaker is discarded as junk, which wastes materials and raises the manufacturing cost.

### SUMMARY OF THE INVENTION

Accordingly, an object of the present invention is to provide a speaker which improves the sound effects thereof. The speaker includes a frame module. The frame module includes a frame body defining a gap on an outer edge thereof, a printed circuit board disposed on a rear surface of the frame body, a magnet mounted in the frame body, and a magnetic washer disposed before the magnet and in the frame body. A phonation module includes a diaphragm and a voice coil assembled in the frame body and surrounding the magnet and the magnetic washer. Two lead wires are led out from the voice coil and led out of the speaker through the gap of the frame body. The voice coil adheres to a back surface of the diaphragm. A steel mask with meshes is mounted in front of the diaphragm.

It can be seen that the lead wires of the voice coil are led out of the speaker through the gap of the frame body and are located in the gap, so the lead wires are not any longer close to the diaphragm, reducing influence upon the diaphragm and improving the sound effects of the speaker.

### BRIEF DESCRIPTION OF THE DRAWINGS

The present invention will be apparent to those skilled in the art by reading the following description of a preferred embodiment thereof, with reference to the attached drawings, in which:

FIG. 1 is a perspective view of a speaker which is cut partially in order to obviously show an inner structure of the speaker of the present invention;

FIG. 2 is a partly exploded view of the speaker;

FIG. 3 is a fully exploded view of the speaker; and

FIG. 4 is a flow chart of a manufacturing method of the speaker.

### DETAILED DESCRIPTION OF THE PREFERRED EMBODIMENT

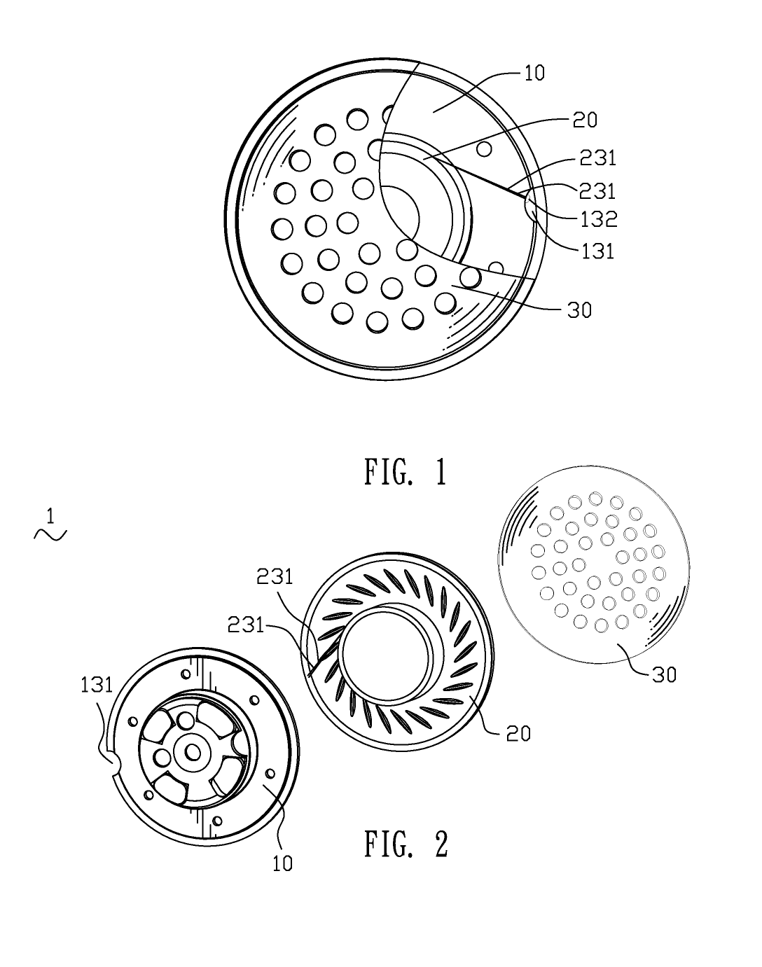

Referring to FIG. 1 and FIG. 2, a speaker 1 in accordance with the present invention includes a frame module 10, a phonation module 20 configured in the front of the frame module 10, and a steel mask 30 fixed in the front of the phonation module 20. All of these will be described in detail hereinafter.

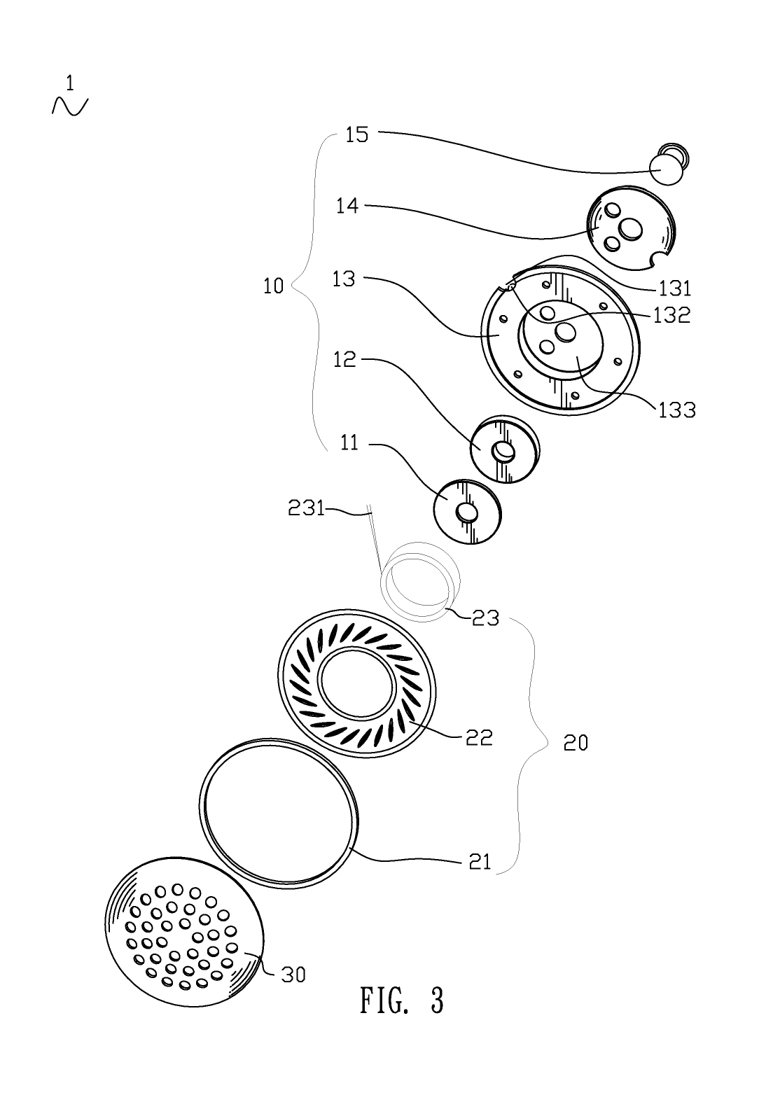

Please refer to FIG. 3. The frame module 10 includes a substantially circular frame body 13. A front surface of the frame body 13 defines a receiving cavity 133 at center thereof. An outer edge of the frame body 13 defines a gap 131 thereon. A printed circuit board 14 is disposed on a rear surface of the frame body 13. A column-shaped magnet 12 is mounted in the receiving cavity 133 of the frame body 13. A magnetic washer 11 is disposed before the magnet 12 and is in the receiving cavity 133. All the printed circuit board 14, the frame body 13, the magnet 12 and the magnetic washer 11 define an axis hole therethrough. A rivet 15 is inserted in the axis holes and integrates the printed circuit board 14, the frame body 13, the magnet 12 and the magnetic washer 11 together.

With reference to FIG. 3 again, the phonation module 20 includes a diaphragm 22 whose center is hollow. The diaphragm 22 is locked in a cannular locating ring 21. The diaphragm 22 is engaged with the front surface of the frame body 13 through the locating ring 21. A cannular voice coil 23 is assembled in the receiving cavity 133 of the frame body 13 and surrounds the magnet 12 and the magnetic washer 11, that is, the magnet 12 and the magnetic washer 11 are accommodated in the cannular voice coil 23. Two lead wires 231 are led out from an exterior surface of the voice coil 23. The two lead wires 231 are coated with colloid to avoid striking between the lead wires 231 and the diaphragm 22. The voice coil 23 adheres to a back surface of the diaphragm 22. The steel mask 30 with meshes is mounted on the locating ring 21 and is in front of the diaphragm 22. The steel mask 30 has a property of permeability.

Referring to FIG. 1, the lead wires 231 of the voice coil 23 are led out of the speaker 1 through the gap 131 of the frame body 13 and are located in the gap 131 by an adhesive 132.

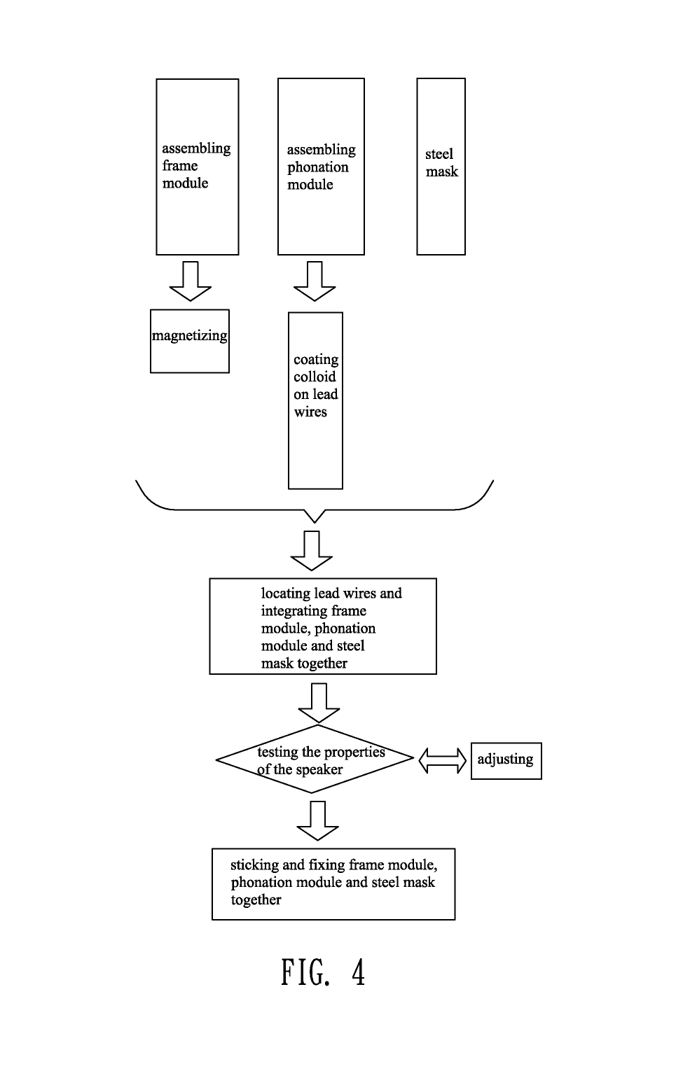

Please refer to FIG. 4 as well as FIG. 3. A manufacturing method of the speaker 1 includes the steps of:
(1) assembling the frame module 10: firstly integrating the printed circuit board 14, the frame body 13, the magnet 12 and the magnetic washer 11 together through the rivet 15;
(2) magnetizing the frame module 10;
(3) assembling the phonation module 20: sticking the diaphragm 22 in the locating ring 21, and then sticking the back surface of the diaphragm 22 to the voice coil 23;
(4) coating colloid on the lead wires 231 to avoid striking between the lead wires 231 and the diaphragm 22;
(5) leading the lead wires 231 out of the speaker 1 through the gap 131 of the frame body 13 and locating the lead wires 231 in the gap 131 by an adhesive 132, then integrating the frame module 10, the phonation module 20 and the steel mask 30 together via a magnetic attraction between the frame module 10 and the steel mask 30;
(6) testing the properties of the speaker 1, and then carrying out the next procedure if the properties of the speaker 1 are up to grade, other else, adjusting and retesting the speaker 1 directly till the properties thereof are qualified; and
(7) sticking and fixing the frame module 10, the phonation module 20 and the steel mask 30 together.

It can be seen that the lead wires 231 of the voice coil 23 are led out of the speaker 1 through the gap 131 of the frame body 13 and are located in the gap 131 by an adhesive 132, so the lead wires 231 not any longer stay close to the diaphragm 22, reducing influence upon the diaphragm 22 and improving the sound effects of the speaker 1.

Additionally, the property test of the speaker 1 is performed before the frame module 10, the phonation module 20 and the steel mask 30 fixed together, which is done through the magnetic attraction between the frame module 10 and the steel mask 30. So if the properties of the speaker 1 are not up to grade, rotate the frame module 10 and the phonation module 20 relatively to adjust the positions of the lead wires 231 or change elements of the speaker 1, and then retest the properties of the speaker 1 until the properties of the speaker 1 are up to grade. The design raises the qualified rate of the speaker 1 manufacture and reduces manufacture cost.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A speaker, comprising:
a frame module, including a frame body, an outer edge of the frame body defining a gap thereon, a printed circuit board disposed on a rear surface of the frame body, a magnet mounted in the frame body, and a magnetic washer disposed before the magnet and in the frame body;
a phonation module, including a diaphragm, a voice coil assembled in the frame body and surrounding the magnet and the magnetic washer, two lead wires led out from the voice coil and led out of the speaker through the gap of the frame body, the voice coil adhering to a back surface of the diaphragm; and
a steel mask with meshes mounted in front of the diaphragm.

2. The speaker as claimed in claim 1, wherein the gap of the frame body defines an adhesive, and the lead wires are located in the gap by the adhesive.

3. The speaker as claimed in claim 1, wherein the two lead wires are coated with colloid to avoid striking between the lead wires and the diaphragm.

4. The speaker as claimed in claim 1, wherein the frame body, the printed circuit board, the magnet and the magnetic washer are integrated together through a rivet.

5. The speaker as claimed in claim 1, wherein the steel mask has a property of permeability.

6. The speaker as claimed in claim 1, wherein the phonation module includes a locating ring, the diaphragm is locked in the locating ring and engages with a front surface of the frame body through the locating ring.

7. The speaker as claimed in claim 6, wherein the steel mask is mounted on the locating ring and in front of the diaphragm.
